(19) United States
(12) Patent Application Publication
(10) Pub. No.: US 2007/0297460 A1
(43) Pub. Date: Dec. 27, 2007

(54) Multi-stream compatible multiplexer and demultiplexer system

(75) Inventors: Keiichi Muneishi, Tokyo (JP); Hideki Kawano, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/651,996

(22) Filed: Jan. 11, 2007

(30) Foreign Application Priority Data
Jun. 26, 2006 (JP) P2006-174888

(51) Int. Cl. H04J 3/06

(52) U.S. Cl. 370/516; 370/535

(57) ABSTRACT

In a process for multiplexing a plurality of transport streams, a transport stream ID and a local time stamp are added to each of the packets that form a transport stream, and in a process for separating a multi-stream obtained by multiplexing the transport streams, the packets forming each transport stream are temporarily stored in a buffer, and at a timing calculated based on the transport stream ID and the local time stamp, the packet interval for the original transport stream is reproduced. In this manner, jitter can be removed.

### TECHNICAL FIELD

The present invention relates to a system for multiplexing a plurality of transport streams to provide a multi-stream, for processing the multi-stream, and for thereafter demultiplexing the multi-stream to recover the transport streams that were present before the multiplexing was performed.

### BACKGROUND

A conventional system conforms to, for example, OC-SP-CCIF 2.0 standards determined by CableLabs. For multiplexing, this system attaches a header to the front of an original transport stream, and provides, in the header, information required for reconstructing the original transport stream. For the details, see, for example, U.S. 2004/0260823 A1 and the following document.

“OpenCable Specifications Multi-Stream CableCard Interface OC-SP-MC-IF-C01-050331”

According to this system, a mechanism is prepared for adding information to be used to reconstruct an original transport stream. However, how the information is to be used to reconstruct the original transport stream is not specifically designated. Thus, when the multiplexing of a plurality of transport streams is performed to obtain a multi-stream and jitter occurs thereafter between the packets constituting the original transport streams, the removal of jitter has conventionally constituted a problem when the original transport streams are to be reconstructed.

### SUMMARY

According to one aspect of the invention, there is provided a multi-stream compatible multiplexer and demultiplexer system including: a multiplexer that multiplexes a plurality of transport streams; a multiplexing controller that adds to individual packets, which form each of the transport streams, a header that includes an ID inherent to a transport stream and a local time stamp consonant with timing information; a demultiplexer that separates, into individual packets, the resultant transport stream obtained by multiplexing and for reconstructing the original transport streams; a buffer that temporarily stores data in the packets that is separated; and a reconstruction controller that reads, for each of the packets, the ID and the local time stamp included in the header, for extracting packets from the buffer at a predetermined timing, in accordance with the local time stamp, the reconstruction controller reconstructing a transport stream of packets for which the same ID is included.

### BRIEF DESCRIPTION OF THE DRAWINGS

In the accompanying drawings:

FIG. 1 is a block diagram showing a multi-stream compatible multiplexer and a demultiplexer system according to the present invention;

FIG. 2 is a diagram showing the structure of a transport stream A according to this invention;

FIG. 3 is a diagram showing the structure of a transport stream B according to this invention; and

FIG. 4 is a diagram showing the structure of a multi-stream obtained by a multiplexer through multiplexing performed in accordance with this invention.

### DETAILED DESCRIPTION

### First Embodiment

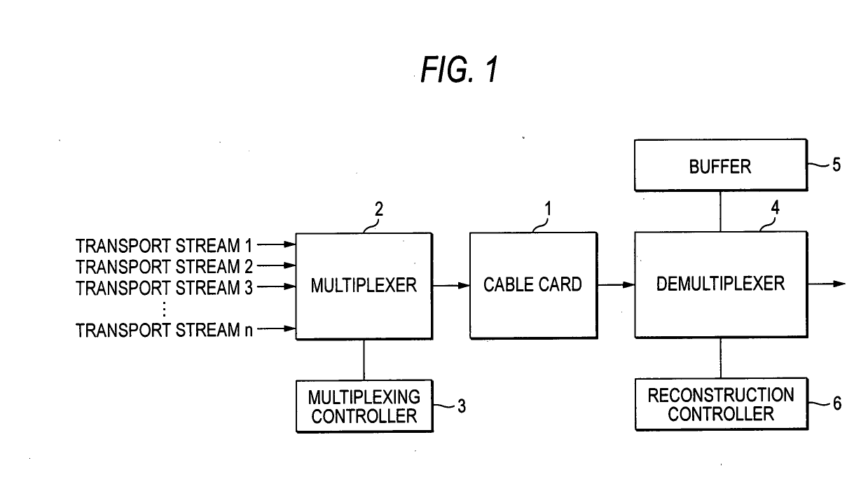

FIG. 1 is a block diagram showing a multi-stream compatible multiplexer and demultiplexer system according to a first embodiment of the present invention. Since a multi-stream compatible CableCARD 1, which is a security module compatible with OpenCable advocated by CableLabs, includes only one type of stream input, a multiplexer 2, which multiplexes a plurality of transport streams to obtain a single multi-stream, is provided at the front stage of the CableCARD 1, for the simultaneous processing of the plurality of transport streams. Furthermore, a multiplexing controller 3 is provided that, during a multiplexing process, adds to a header transport stream IDs and local time stamps. The CableCARD 1 unlocks the security for the multi-stream, so that a user of this system can accept a service, and can transmit, thereafter, the multi-stream to a demultiplexer 4. The demultiplexer 4 separates the multi-stream and reconstructs the arrays of packets in the original transport streams. At this time, a gap or jitter could occur at a packet interval. In order to remove jitter, a buffer 5 is provided for the demultiplexer 4 for the temporary storage of the obtained packets. A reconstruction controller 6, which controls separation and reconstruction, extracts transport stream IDs and local time stamps from the headers for the individual packets in the multi-stream. Then, sequentially, based on this information, the reconstruction controller 6 extracts packets from the buffer 5 at the same time intervals as those provided for the packets of the individual transport streams before they were multiplexed by the multiplexer 2, and transmits the packets to the succeeding stage. As a result, the time intervals for the packets of transport streams that are being reconstructed are the same as the time intervals before the transport streams were multiplexed. Thus, during the decoding process, the occurrence can be prevented of an obstacle such that, because of increases in the packet intervals, all data intervals become equal to or greater than the interval of a decoding time stamp that is added during encoding, and the decoding is adversely affected.

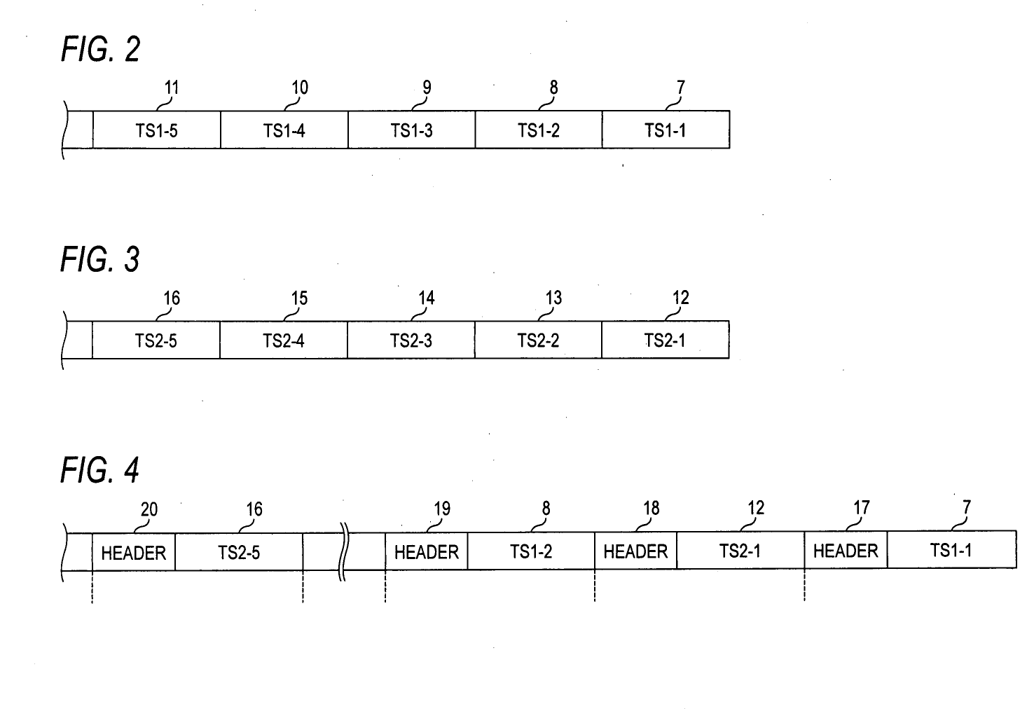

FIGS. 2 and 3 are diagrams showing the structures of transport streams A and B, respectively. In FIG. 2, a transport stream A is formed of a plurality of packets having a fixed length, such as a first packet 7, a second packet 8, a third packet 9, a fourth packet 10 and a fifth packet 11. Similarly, in FIG. 3, a transport stream B is formed of a plurality of packets having a fixed length, such as a first packet 12, a second packet 13, a third packet 14, a fourth packet 15 and a fifth packet 16.

FIG. 4 is a diagram showing the structure of a multi-stream obtained after the multiplexer 2 has multiplexed the transport streams A and B in FIGS. 2 and 3. The multiplexing is performed in the order in which the individual packets are processed, and at this time, headers are added by the multiplexing controller 3. Each of the headers that are added includes a transport stream ID for identifying the packet of the transport stream. Furthermore, each header that is added also includes information of the packet interval of a transport stream before it was multiplexed, e.g., a local time stamp indicating the time the pertinent packet entered the multiplexer 2.

Since the same transport stream ID is added to the packets 7, 8, 9, 10 and 11 in the transport stream A, 0×AA, for example, is added to header 17 and header 19. Further, since a different transport stream ID is added to the packets 12, 13, 14, 15 and 16 in the other transport stream B, 0xBB, for example, is added to header 18 and to header 20.

Since the times at which individual packets were input to the multiplexer 2 are provided as the local time stamps, for example, 0x00000001 is added to header 17, 0x00000005 is added to header 18, 0x0000000B is added to header 19, and 0x00000002D is added to header 20.

The demultiplexer 4 separates the multi-stream and reconstructs the arrays of the original transport streams. At this time, the packet interval used before the multiplexing is lost in the array of packets that arrives at the demultiplexer 4, because a packet of a different transport stream may be inserted between packets that were sequential before the multiplexing. Additionally, when there is a time difference for the packet processing of the transport streams by the CableCard 1, or assuming that the transmission of packets for a specific transport stream is disconnected by channel tuning or that packets of a new transport stream are added, a variance can occur in the interval at which packets arrive at the demultiplexer 4, and this becomes jitter.

In order to remove the jitter, the reconstruction controller 6, which controls reconstruction and separation, extracts a transport stream ID and a local time stamp from the header of an arriving packet, and temporarily stores the packet in the buffer 5. Thereafter, the reconstruction controller 6 starts a counter by using, as a reference, the local time stamp for the first packet that arrives, and then, based on the transport stream ID, determines for which transport stream the individual packets are to be reconstructed. Further, the reconstruction controller 6 adds to the local time stamp of the arriving packet an offset time, held by the reconstruction controller 6, and outputs the packet to the succeeding stage at a timing such that the obtained time is synchronized with the time held by the counter. Thus, the transport stream is reconstructed at the original packet interval, and is output to the succeeding stage.

According to the system having this arrangement, when the interval for packets of a transport stream of the same program differ between before the multiplexing and immediately before the separating, during the separation process the original transport stream can be reconstructed using the same packet interval as the one used before the multiplexing. Thus, an obstacle to the performance of the decoding process can be prevented, or can be considerably reduced.

### Second Embodiment

For the reconstruction controller 6 that controls separation and reconstruction, a register may be provided that permits a user to designate an offset time. According to this arrangement, the user can calculate and designate an optimal offset time based on the capacity of the buffer of a system or a delay time for stream transmission in the system.

### Third Embodiment

For the reconstruction controller 6 that controls separation and reconstruction, different offset times may be designated for a plurality of registers, so that the offset time can be selected in accordance with the bit rate of transport streams that enter the multiplexer 2. Since the capacity of the buffer 5 is determined in accordance with the input bit rate, the offset time and the number of transport streams to be multiplexed, the capacity of the buffer 5 can be minimized, so long as the offset time can be changed in accordance with the input bit rate.

### Fourth Embodiment

Furthermore, for the reconstruction controller 6 that controls separation and reconstruction, different offset times may be designated for a plurality of registers, so that the offset time can be selected in accordance with the bit rate of transport streams output by the multiplexer 2. When the bit rate of transport streams output by the multiplexer 2 is a variable, the capacity of the buffer 5 also varies in accordance with the bit rate of the transport streams output by the multiplexer 2. Thus, the capacity of the buffer 5 can be minimized, so long as the offset time can be changed in accordance with the bit rate of the transport streams output by the multiplexer 2.

### Fifth Embodiment

Additionally, for the reconstruction controller 6 that controls separation and reconstruction, different offset times may be designated for a plurality of registers, so that data for an offset time can be selected in accordance with the number of transport streams to be multiplexed. Since the capacity of the buffer 5 is determined in accordance with the input bit rates of transport streams, the offset time and the number of transport streams to be multiplexed, the capacity of the buffer 5 can be minimized, so long as the offset time can be changed in accordance with the number of transport streams to be multiplexed.

In the embodiments described above, even when, before being multiplexed and immediately prior to being separated, the interval between packets in each transport stream differs, during the separation process each transport stream need merely be reconstructed, using the same packet interval as before the multiplexing, to prevent the formation of a barrier at the time decoding is performed.

According to the present invention, there is provided a multi-stream compatible multiplexer and demultiplexer system that performs the removal of jitter from a multi-stream and the reconstruction, from the multi-stream, of transport streams.

What is claimed is:

1. A multi-stream compatible multiplexer and demultiplexer system comprising:
a multiplexer that multiplexes a plurality of transport streams;
a multiplexing controller that adds to individual packets, which form each of the transport streams, a header that includes an ID inherent to a transport stream and a local time stamp consonant with timing information;
a demultiplexer that separates, into individual packets, the resultant transport stream obtained by multiplexing and for reconstructing the original transport streams;
a buffer that temporarily stores data in the packets that is separated; and
a reconstruction controller that reads, for each of the packets, the ID and the local time stamp included in the header, for extracting packets from the buffer at a predetermined timing, in accordance with the local time stamp, the reconstruction controller reconstructing a transport stream of packets for which the same ID is included.

2. The multi-stream compatible multiplexer and demultiplexer system according to claim 1, wherein the reconstruction controller has an offset time setup function, and
wherein, by employing as a reference a time indicated by a local time stamp, included in a header of a packet that arrived at the demultiplexer first, the reconstruction controller extracts corresponding packets from the buffer at a timing that matches a time obtained by adding, to a time indicated by the local time stamp included in the header of each of the packets, an offset time determined by the offset time setup function.

3. The multi-stream compatible multiplexer and demultiplexer system according to claim 2, wherein the offset time setup function is capable of setting a plurality of offset times and of switching between the offset times in accordance with a bit rate for a transport stream that enters the multiplexer.

4. The multi-stream compatible multiplexer and demultiplexer system according to claim 2, wherein the offset time setup function is capable of setting a plurality of offset times and of switching between the offset times in accordance with a bit rate for a transport stream that is output by the multiplexer.

5. The multi-stream compatible multiplexer and demultiplexer system according to claim 2, wherein the offset time setup function is capable of setting a plurality of offset times and of switching between the offset times in accordance with the number of transport streams to be multiplexed.
